(19) United States
(12) Patent Application Publication
(10) Pub. No.: US 2008/0250939 A1
(43) Pub. Date: Oct. 16, 2008

(54) Freestanding Deep Fat Fryer

(75) Inventors: Wong Poh See, Singapore (SG); Wong Shue Leong, Singapore (SG)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kang Li Far East Pte Ltd.

(21) Appl. No.: 12/088,473

(22) PCT Filed: Oct. 3, 2005
(86) PCT No.: PCT/SG2005/000336

§ 371 Date: Mar. 28, 2008

(51) Int. Cl. A47J 37/12; A47J 27/00

(52) U.S. Cl. 99/403; 126/376.1

(57) ABSTRACT

A freestanding deep fat fryer (100) having a vat adapted for containing cooking fat or oil, the vat having side (130,131), rear (133) and front walls and a base, in use the front wall of the vat being located nearest a user. At least one electrical heating element within the vat, the heating element heating (150) the cooking fat or oil. The heating element is secured to the front wall of the vat near the base of the vat. The heating element being provided with electricity through the front wall of the vat. The freestanding deep fat fryer further having a ventilation hood (110) above the vat and a fire extinguisher. The fire extinguisher having at least one fire detection sensor (301) and at least one nozzle (302,303) for spraying fire extinguishing foam. The sensor and the nozzle being located in the ventilation hood above the vat. The fire detection sensor being connected to a controller and the nozzles being fluidly connected to a pressurized container containing fire extinguishing foam. The controller when the sensors detects the outbreak of a fire releasing the foam from the container, the foam being sprayed by the nozzles over the vat.

### FIELD OF THE INVENTION

The present invention relates to a deep fat fryer, particularly to freestanding deep fat fryers for use in commercial kitchens.

### BACKGROUND OF THE INVENTION

Current deep fat fryers invariably have their heating elements mounted so that it is difficult to replace them as they wear out or are damaged. Further individual elements may not be replaced and sets of elements are replaced together, when only one element needs replaced. Additionally cooking baskets easily damage the electrical elements. This damage happens as the cooking baskets are placed on top of the elements in the vat.

### SUMMARY OF THE INVENTION

An object of at least one embodiment of the invention is to provide an improved deep fat fryer that overcomes the disadvantages of the prior art or at least provides the public or industry with a useful choice.

Another object is to provide a standalone deep fat fryer incorporating a fire extinguisher.

Accordingly in a first aspect the invention may be said to consist in a freestanding deep fat fryer having:
an open vat adapted for containing cooking fat or oil, said vat having a base, side, rear and front walls, in use said front wall of said vat being located nearest a user;
at least one electrical heating element within said vat, said electrical heating element heating said cooking fat or oil; said heating element being secured to and passing through the front wall of said vat, near the base of said vat, said electrical heating element being provided by power from the front of said front wall of said vat;
a ventilation hood above said vat; and
a fire extinguisher, said fire extinguisher having at least one fire detection sensor and at least one nozzle for spraying fire extinguishing foam, said at least one sensor and said at least one nozzle being located in said ventilation hood above said vat, said at least one fire detection sensor being connected to a controller, said nozzle(s) being fluidly connected to a pressurized container containing fire extinguishing foam, said controller when said sensors detects the outbreak of a fire releasing said foam from said container, said foam being sprayed by said nozzles over said vat.

Preferably in the event of a fire being detected by said sensors, power to said at least one electrical heating element is shut off by said controller.

Preferably said controller consists of a controller for said fire extinguisher and a system controller, said fire extinguisher controller and said system controller working together.

Preferably said at least one electrical heating element is a plurality of heating elements.

Preferably said plurality of heating elements is three.

Preferably the failure of one element results in the controller shutting off power to all the elements.

Preferably said deep fat fryer having at least one thermostat within said vat, wherein the failure of a thermostat results in said controller issuing a warning and shutting off power to said at least one element.

Preferably said ventilation hood further includes an air filter and at least one extractor fan, for extracting cooking odors from said vat.

Preferably said freestanding deep fat fryer includes a partially open cabinet, said vat being located within said cabinet, the top of said vat being at a working height for a user, wherein the back and side walls above said vat are double skinned.

Preferably said back wall of said cabinet includes a frying basket hanger.

Preferably said freestanding deep fat fryer further including a manual switch to activate said fire extinguisher.

Preferably said freestanding deep fat fryer further includes a fire warning light activated by said fire extinguisher controller.

Preferably said freestanding deep fat fryer further including a siren activated by said fire extinguisher controller.

Preferably said vat includes a lip inside the vat on at least two walls, said lip being located at a level above said at least one element and being parallel to the top of said vat, said freestanding deep fat fryer further including a screen that in use sits on said lip, said screen being shaped to fit securely within said vat, said screen protecting said at least one element from damage by frying baskets

Preferably said vat includes a drain said drain having a valve to control the flow of cooking oil or fat from said vat.

In a second aspect the invention may be said to consist in a vat for a deep fat fryer, said vat adapted for containing cooking fat or oil, said vat having a base, side, rear and front walls, in use said front wall of said vat being located nearest a user, at least one electrical heating element within said vat, said electrical heating element heating said cooking fat or oil; said heating element being secured and passing through the front wall of said vat, near the base of said vat

Preferably said at least one electrical heating element is a plurality of heating elements.

Preferably said plurality of heating elements is three.

Preferably said plurality of heating elements are controlled by a controller and the failure of one element results in the controller shutting of power to all the elements.

Preferably said vat having at least one thermostat within said vat, wherein the failure of a thermostat results in said controller issuing a warning and shutting off power to said at least one element.

Preferably said vat includes a lip inside the vat on at least two walls, said lip being located at a level above said at least one element and being parallel to the top of said vat, said vat further including a screen that in use sits on said lip, said screen being shaped to fit securely within said vat, said screen protecting said at least one element from damage by frying baskets.

Preferably said vat includes a drain said drain having a valve to control the flow of cooking oil or fat from said vat.

The invention may further be said to consist in any alternative combination of parts or features mentioned herein or shown in the accompanying drawings. Known equivalents of these parts or features, which are not expressly set out, are nevertheless deemed to be included.

### BRIEF DESCRIPTION OF THE DRAWINGS

Disclosed embodiments and methods of utilizing the invention will be further described, with reference to the accompanying figures, by way of example only and without intending to be limiting, wherein;

FIG. 1 shows a front view of the fat fryer according to an illustrated embodiment of the present invention,

FIG. 2 shows a partial cut away right side view of the fat fryer showing the fire extinguisher zones according to an illustrated embodiment of the present invention,

FIG. 3 shows a partial cut away left side view of the fat fryer according to an illustrated embodiment of the present invention,

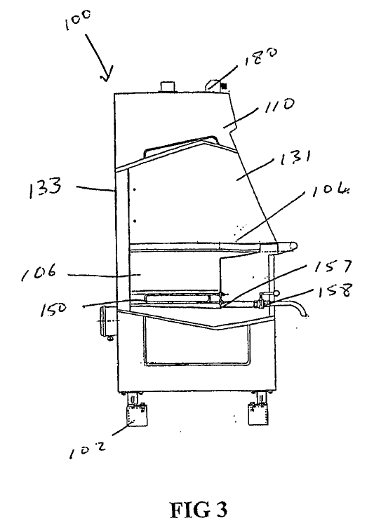

FIG. 4 shows a further partial cut away right side view of the fat fryer according to an illustrated embodiment of the present invention,

FIG. 5 shows a front view of a vat of an illustrated embodiment of the present invention, and

FIG. 6 shows a plan view of a vat of an illustrated embodiment of the present invention.

### DETAILED DESCRIPTION OF THE DISCLOSED EMBODIMENTS

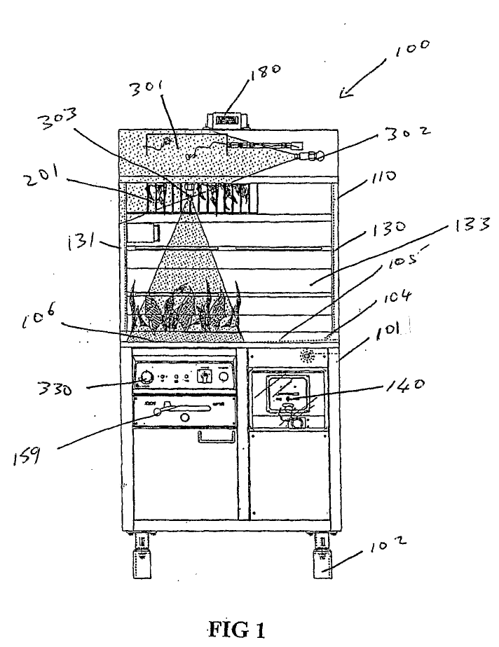

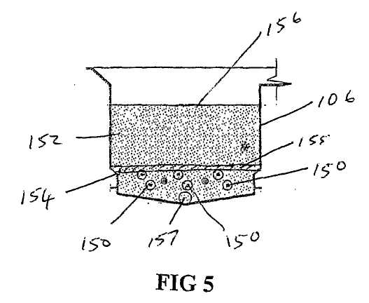

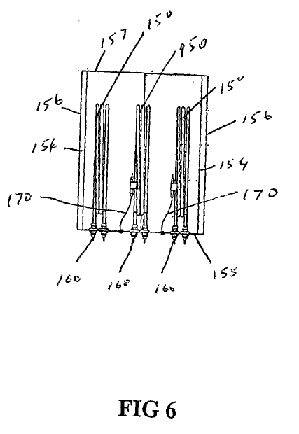

Referring to the figures an illustrative embodiment is shown. The freestanding deep fat fryer 100 includes a cabinet 101 having lockable wheels 102, to allow the cabinet to be moved and yet locked in place for use. Referring to FIG. 1 the cabinet has a cooking area 104, on one side of the cooking area is a sunken vat 105 and on the other side is a work surface 106. Referring to FIGS. 5 and 6, the vat 105 contains heating elements 150, the heating elements 150 are used for heating oil or fat 152 for cooking.

Above the work surface is an integral hood 110, which contains filters 201, an extractor fan 202, and a fire extinguisher. The hood, 110 is supported by side 130, 131 and rear wall/panels 133. The side 130, 131 and rear 133 panels are made of double skins to reduce the heat on the exterior of the fryer 100.

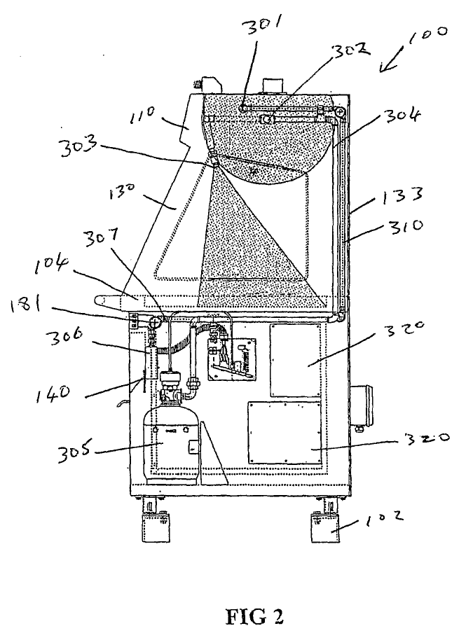

Referring to FIG. 2 the fire extinguisher includes detectors 301 and nozzles 302, 303. The nozzles 302, 303 are connected by a pipe 304 to a container 305, which contains the fire dousing foam. The fire detectors 301 are connected to the fire extinguisher controller 306 by an electrical cable 310. The electrical cable 310 is enclosed within a pipe 307 to protect the cable 310 from heat, both in normal use and in the event of a fire.

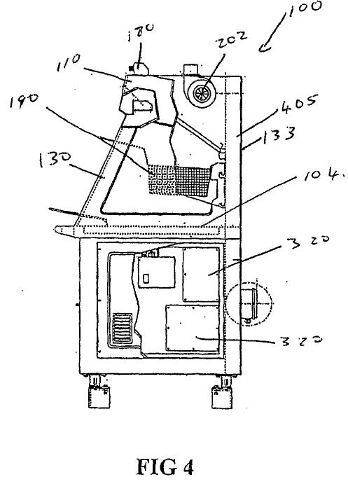

In addition to being set off automatically a pull cord or switch 140 may be used to set the fire extinguisher off. Both the pipe for the foam 304 and the pipe containing the electrical cables 307 are enclosed between the double skin of the rear wall 133 of the deep fat fryer 100. The double skin 405 rear wall 133 can clearly be seen in FIG. 4.

The fire extinguisher controller 306 is integrated with the system power controllers 320 and in the event of a fire, electrical power is cut to the heating elements 150. In the event of a fire a siren 180 and light 181 alert users to the occurrence of fire.

With reference to FIGS. 5 and 6 the vat 106 has on two sides a shelf 154 into which a filer or tray 155 may be placed. The filter or tray 155 is shaped to fit securely inside the vat 106 and is parallel to the top of the cooking fat level 156. The tray or filter 155 protects the elements 150 from damage by cooking baskets 190 which can be seen in FIG. 4.

At the bottom of the vat 106 a drain 157 is provided for draining the vat 106. A valve 158 controls the flow of fat or oil from the vat 106. The user controls the valve using handle 159

The heating elements 150 are secured to the front wall 155 of the vat, with electrical connections made outside the vat to electrical connectors 160. Because the elements are mounted through the front wall it is easier to replace damaged or broken elements 150 without having to move the fryer 100 to allow access

The heating elements 150 are controlled by the system controller 320 and in the event of an element 150 failing the controller 320 shuts off power to all the elements 150 and a warning light on the control panel 330 is lit.

Thermostats 170 provide the temperature of the oil or fat to the controller 320, and the controller 320 in response to instructions from the user control panel 330 alters the power levels provided to the elements 150. In the event of a thermostat failing, the controller 320 shuts off power to the elements 150 and a warning light on the control panel 330 is lit.

The foregoing describes the invention with reference to the disclosed embodiment. Alterations and modifications as will be obvious to those skilled in the art are intended to be incorporated within the scope of the invention as defined in the accompanying claims.

That which is claimed:

1. A freestanding deep fat fryer comprising:
an open vat adapted for containing cooking fat or oil, said vat having a base, side, rear and front walls, in use said front wall of said vat being located nearest a user;
at least one electrical heating element within said vat, said electrical heating element heating said cooking fat or oil; said heating element being secured to and passing through the front wall of said vat, near the base of said vat, said electrical heating element being provided by power from the front of said front wall of said vat;
a ventilation hood above said vat; and
a fire extinguisher, said fire extinguisher having at least one fire detection sensor and at least one nozzle for spraying fire extinguishing foam, said at least one sensor and said at least one nozzle being located in said ventilation hood above said vat, said at least one fire detection sensor being connected to a controller, said at least one nozzle being fluidly connected to a pressurized container containing fire extinguishing foam, said controller when said sensors detects the outbreak of a fire releasing said foam from said container, said foam being sprayed by said nozzles over said vat.

2. A freestanding deep fat fryer as claimed in claim 1 wherein in the event of a fire being detected by said sensors, power to said at least one electrical heating element is shut off by said controller.

3. A freestanding deep fat fryer as claimed in claim 2 wherein said controller consists of a controller for said fire extinguisher and a system controller, said fire extinguisher controller and said system controller working together.

4. A freestanding deep fat fryer as claimed in claim 1 wherein said at least one electrical heating element is a plurality of heating elements.

5. A freestanding deep fat fryer as claimed in claim 4 wherein said plurality of heating elements is three.

6. A freestanding deep fat fryer as claimed in claim 4 wherein the failure of one element results in the controller shutting off power to all the elements.

7. A freestanding deep fat fryer as claimed in claim 1 further having at least one thermostat within said vat, wherein the failure of a thermostat results in said controller issuing a warning and shutting off power to said at least one element.

8. A freestanding deep fat fryer as claimed in claim 1 wherein said ventilation hood further includes an air filter and at least one extractor fan, for extracting cooking odors from said vat.

9. A freestanding deep fat fryer as claimed in claim 1 wherein said freestanding deep fat fryer includes a partially open cabinet, said vat being located within said cabinet, the top of said vat being at a working height for a user, wherein the back and side walls above said vat are double skinned.

10. A freestanding deep fat fryer as claimed in claim 1 wherein said back wall of said cabinet includes a frying basket hanger.

11. A freestanding deep fat fryer as claimed in claim 1 further including a manual switch to activate said fire extinguisher.

12. A freestanding deep fat fryer as claimed in claim 1 further includes a fire warning light activated by said fire extinguisher controller.

13. A freestanding deep fat fryer as claimed in claim 1 further includes a siren activated by said fire extinguisher controller.

14. A freestanding deep fat fryer as claimed in claim 1 wherein said vat includes a lip inside the vat on at least two walls, said lips being located at a level above said at least one element and being parallel to the top of said vat, said freestanding deep fat fryer further including a screen that in use sits on said lip, said screen being shaped to fit securely within said vat, said screen protecting said at least one element from damage by frying baskets.

15. A vat for a deep fat fryer, said vat adapted for containing cooking fat or oil, said vat comprising a base, side, rear and front walls, in use said front wall of said vat being located nearest a user, at least one electrical heating element within said vat, said electrical heating element heating said cooking fat or oil; said heating element being secured and passing through the front wall of said vat, near the base of said vat.

16. A vat for a deep fat fryer as claimed in claim 15 wherein said at least one electrical heating element is a plurality of heating elements.

17. A vat for a deep fat fryer as claimed in claim 16 wherein said plurality of heating elements is three.

18. A vat for a deep fat fryer as claimed in claim 16 wherein said plurality of heating elements are controlled by a controller and the failure of one element results in the controller shutting of power to all the elements.

19. A vat for a deep fat fryer as claimed in claim 18 further having at least one thermostat within said vat, wherein the failure of a thermostat results in said controller issuing a warning and shutting off power to said at least one element.

20. A vat for a deep fat fryer as claimed in claim 15 wherein said vat includes a lip inside the vat on at least two walls, said lips being located at a level above said at least one element and being parallel to the top of said vat, said vat further including a screen that in use sits on said lip, said screen being shaped to fit securely within said vat, said screen protecting said at least one element from damage by frying baskets.

21. A vat for a deep fat fryer as claimed in claim 15 wherein said vat includes a drains said drain having a valve to control the flow of one of cooking oil and fat from said vat.
